(19) United States
(12) Patent Application Publication
(10) Pub. No.: US 2016/0217457 A1
(43) Pub. Date: Jul. 28, 2016

(54) PARKING FACILITY SECURE PAYMENT SYSTEM

(71) Applicant: Clear Token Inc., Denver, CO (US)

(72) Inventors: Lawrence Berman, Delray Beach, FL (US); Stanley J. Wolfson, Denver, CO (US)

(21) Appl. No.: 15/099,465

(22) Filed: Apr. 14, 2016

Related U.S. Application Data
(63) Continuation-in-part of application No. 14/709,001, filed on May 11, 2015.
(60) Provisional application No. 61/992,260, filed on May 13, 2014.

(51) Int. Cl. G06Q 20/36; G06Q 20/10; G06Q 10/02; G06Q 20/02

(52) U.S. Cl. CPC G06Q 20/367; G06Q 20/02; G06Q 20/10; G06Q 10/02

(57) ABSTRACT

A secure payment system and method at a parking facility are disclosed. In an example, the secure payment system includes a remote payment processor to confirm payment by a customer for a transaction for a parking facility, and to issue a token to the customer for the transaction. The token has a transaction index and a transaction code for the parking facility. The system also includes an interface module for the parking facility configured to receive the token from the customer for the transaction. The system also includes an electronic token handler device having a token processing module to confirm validity of the token based on the transaction index and the transaction code of the token. The electronic token handler device issues a signal to actuate control electronics of the parking facility in response to a valid token.

### RELATED APPLICATIONS AND PRIORITY CLAIM

This application is a continuation-in-part (CIP) patent application of U.S. patent application Ser. No. 14/709,001 titled “Secure Payment System and Method” of Stanley J. Wolfson, filed on May 11, 2015, which claims the priority benefit of U.S. Provisional Patent Application No. 61/992,260 titled “Secure payment system” of Stanley J. Wolfson, filed on May 13, 2014, and is also related to U.S. Provisional Patent Application No. 61/951,875 titled “Secure payment system” of Stanley J. Wolfson, filed on Mar. 12, 2014 and corresponding U.S. patent application Ser. No. 14/645,196 filed on Mar. 11, 2015, and U.S. patent application Ser. No. 14/671,456 titled “Parking Meter Payment Device” of Berman, et al. filed on Mar. 27, 2015, each of which is hereby incorporated by reference for all that is disclosed as though fully set forth herein.

### BACKGROUND

Increasingly, our global society is moving towards a culture in which transactions, whether social or business in nature, take place electronically via wireless devices including for example, mobile phones, tablets, computers and other electronic devices through connection to the Internet or wireless provider network (e.g., 3G, 4G networks). While these transactions can be easily implemented in an online storefront, and even in a physical store by having a store clerk available to assist customers and/or reduce the occurrence of fraud (e.g., data processing and so-called “skimming” of credit card information), some purchases may lack such a facilitator, for example at a parking facility. Use of parking services (e.g., a valet) and parking facilities often requires the user to have coins, credit cards, prepaid cards, and/or dollar bills available.

### BRIEF DESCRIPTION OF THE DRAWINGS

FIG. 1A is an illustration of an example secure payment system implemented by a parking facility.

FIG. 1B is a block diagram of an example secure payment system for a parking facility.

FIGS. 1C-1D show an example parking facility payment device, wherein C) is a front view and D) is a side view.

FIG. 2A is a high-level diagram of a token provider of the secure payment system for a parking facility.

FIG. 2B is a diagram of a token handler of the secure payment system for a parking facility.

FIG. 2C is another diagram of a token handler of the secure payment system for a parking facility.

FIG. 3 illustrates example communication and commands which may be implemented by the secure payment system for a parking facility.

FIG. 4 illustrates an example coding scheme to build a token.

FIG. 5 illustrates an example coding scheme to validate a token and process a transaction at a parking facility.

FIG. 6 is a flow chart illustrating example operations which may implement a secure payment method at a parking facility.

FIG. 7 is a flow chart illustrating example operations of a token provider to implement a secure payment method at a parking facility.

FIG. 8 is a flow chart illustrating example operations to implement a secure payment method at a parking facility.

### DETAILED DESCRIPTION

A parking facility secure payment system and method is disclosed which may be implemented to pay for use of a parking facility (e.g., multi-space parking lot(s) or garage(s) and/or valet using the lot(s) or garage(s)). Payment is handled on-site by an electronic device such as, but not limited to, a mobile phone, without needing to have a physical credit card or traditional cash on hand. In an example, a user (e.g., a customer) may issue a request for a transaction for a parking facility. The request is processed to confirm payment, and a token (e.g., a secure digital certificate such as an electronic data file) is issued to the customer.

The customer may then transmit (e.g., wirelessly transmit) the token to a token handler for a parking facility. In an example, the token handler is provided on (or as an integral part of) an parking area access control device (e.g., a gate). In an example, the token handler may be utilized by a valet service, i.e., a service that parks vehicles for multiple customers. The token handler validates the token and negotiates the transaction, for example, by actuating operation of a gate or other parking area access control device to enable entry and/or exit of a vehicle from a designated parking area.

An example token handler includes a wireless certificate reader configured to receive a digital certificate or “token” from a mobile computing device. In use, a mobile computing device (e.g., mobile phone) may include an installed application or “app”. When the mobile computing device is activated via the app, it searches for any token handlers in the area (e.g., a parking facility) which may be operated with the digital payment system. In an example, the app may display a list of token handlers in the user's vicinity which accept payment via the secure payment system. In other examples, the customer may manually identify the token handler (e.g., by entering an ID for a parking facility in the app).

In an example, where a parking facility with a valet or parking attendant implements the secure payment system, the user can pay securely without having to pay the individual valet or parking attendant. In addition, the owner or operator of the parking facility can retrieve space usage and availability reports, thereby enabling the owner to better understand customer needs and parking patterns.

It is noted that the wireless certificate reader does not need to establish a connection to the payment provider or other entity. As such, the token handler does not need to be configured with an expensive to install and maintain modem or other communications system. The wireless certificate reader can instead be a BLUETOOTH™ or other near-field communication protocol for communicating with the mobile computing device in proximity to the token handler.

In addition, the parking facility does not need to be in an area having mobile phone/data service. For example, the user may request a token at their home, and then use that token at a parking facility that is out of a service area by providing it to the token handler for the parking facility via the BLUETOOTH™ or other near-field communication protocol.

In an example, data to validate the token received at the token handler is stored in the local memory of the token handler before a transaction is initiated at the token handler. As such, no communication connection is required between the digital payment system and the third party payment system. This enables use of the digital payment system without having to provide expensive communication connections by the parking facility.

The token may be a one-time-use digital certificate. In an example, after the token has been confirmed and the transaction negotiated (i.e., the gate has been actuated), the corresponding information stored in the token handler may be “wiped” clean (e.g., the code set to zero or otherwise erased). This helps ensure that the goods and/or services delivered by the token handler have been paid for and that the same digital certificate is not being re-used. In another example, the token may include an expiration tag, so that a customer cannot purchase tokens in advance to avoid price increases.

In an example, the secure payment system may operate with a third-party payment processor to handle payments for the user without the user having to provide any credit card or other form of payment (or personal or other information) at the parking facility. For example, the user may have already provided payment information (e.g., credit card or bank account information) to the third-party payment processor, who is a trusted payment processor such as the user's bank, credit card issuer, direct carrier billing (e.g., billing to a cell phone account), digital currency, or other payment service, and therefore the user does not have to provide any payment information to the token handler or the token provider. As such, the secure payment system reduces the opportunity for fraud, while providing the user with the convenience of a so-called “cashless” transaction. Likewise, the owner of the parking facility receives payment from a trusted third-party payment processor without risk that the payment form (e.g., credit card) is stolen or unauthorized.

The secure payment system may support simple linear and/or complex dynamic rate structures. For example, the user may park prior to parking regulations starting, and have the unit only charge after the regulations go into effect. Example regulations may include higher prices during peak hours (e.g., congestion pricing).

The secure payment system may be implemented at parking facilities to accept a variable rate structure. For example, parking rates can change for special events. In an example, the secure payment system can be pre-programmed or programmed on the fly for these types of changes to the rate that is charged. In addition, discounts may be offered (e.g., a coupon could be applied via the app). Indeed, even free parking may be offered.

The secure payment system also enables parking facilities to designate all or portions of a parking area (e.g., designated for reserved parking, VIP parking, event parking, time-limited zones, etc.). Likewise, all or a portion of a parking area may be designated for permit parking, residential parking, airport or other area-specific parking (e.g., beach parking, street parking).

The secure payment system also enables the user to extend parking without having to go back to the lot or parking attendant. The time left is shown on the user's mobile phone. A warning message may be delivered to the user alerting the user that their paid for time is ending.

It is noted that the systems and methods described herein are not limited to any particular type of parking facility, mobile device, and/or payment processor. The digital payment system may be used in an attended and/or unattended environment, and may be used to enable operation of any type of parking facility.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the term “token” as it refers to a type of “digital certificate” (or “electronic information” or “data packet”) is intended to broadly designate electronic data or information provided by the system to a mobile device, which may or may not be further processed by the mobile device, and which is capable of being processed in conjunction with data or information provided for a parking facility to verify or otherwise confirm payment.

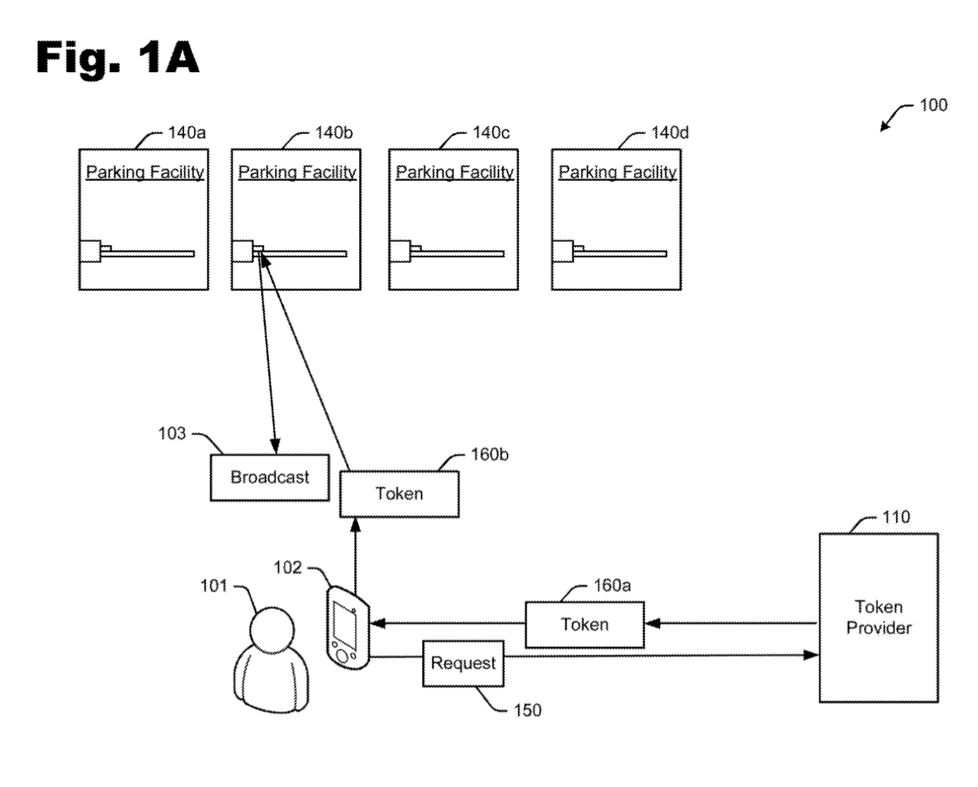

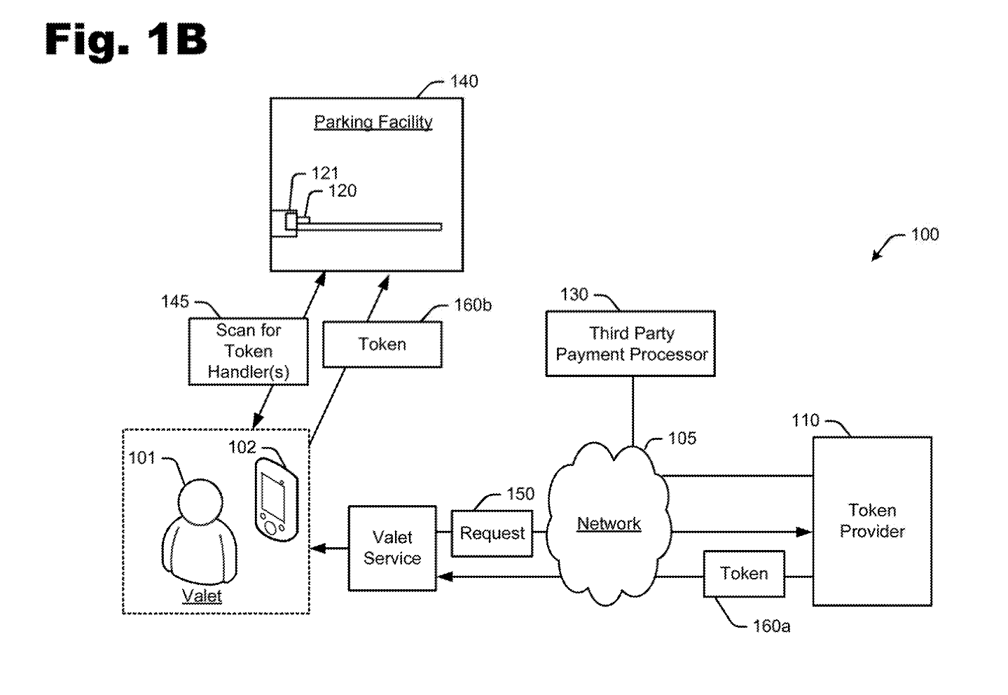

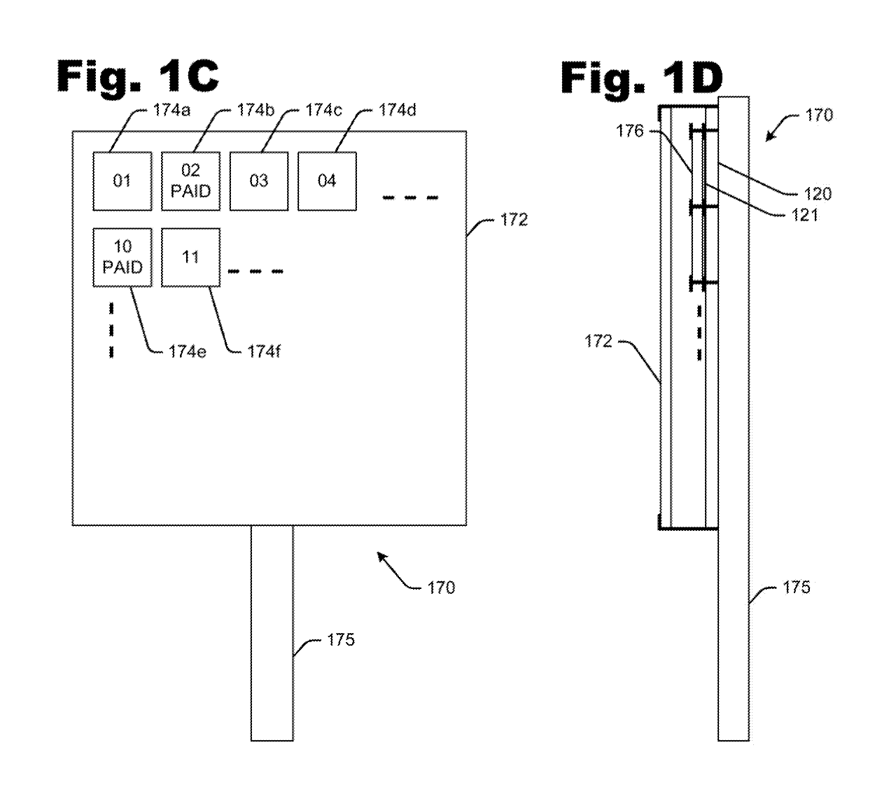

FIG. 1A is an illustration of an example secure payment system 100 as it may be implemented for a parking facility. FIG. 1B is a block diagram of an example secure payment system 100. System 100 may be implemented with any of a wide variety of computing devices. Each of the computing devices may include memory, storage, and a degree of data processing capability at least sufficient to manage a communications connection either directly with one another or indirectly (e.g., via a network). At least one of the computing devices is also configured with sufficient processing capability to execute program code and/or other logic described herein.

In an example, the secure payment system 100 may be implemented by a token provider 110 providing a digital payment service accessed by a user 101 via a client device 102. The user may be a customer (e.g., the owner of the vehicle to be parked), or a valet (e.g., a person authorized to park a vehicle). The client device 102 may be any suitable computer or computing device (e.g., laptop computer or other mobile device such as a phone or tablet) capable of accessing a third party payment processor 130.

Of course, the token provider 110 and client device 102 are not limited to any particular type of devices (e.g., watches and other wearable technology), and may also include other devices that are traditionally not considered to be a part of the mobile environment (e.g., desktop computing devices or terminals).

In an example, the secure payment system 100 may be implemented with one or more communication network 105, such as a local area network (LAN) and/or wide area network (WAN) and/or other communications platform such as a mobile communications network. In an example, the network includes the Internet and/or other mobile communications network (e.g., a 3G or 4G mobile device network).

In an example, the secure payment system 100 provides a way for the user 101 to pay to park at a parking facility 140a-d (referred to generally herein as parking facility 140), using the user's own mobile device 102, via the digital payment service implemented by the token provider 110, but without having to provide payment at the parking facility 140 because access to payment information is maintained by third party payment processor(s) 130 (e.g., a bank or credit card company).

In use, a mobile device 102 (e.g., a mobile phone) may include an installed application or “app”. When the mobile device 102 is activated via the app, the mobile device 102 searches 145 for any parking facilities 140 in the area which are configured for operation in the environment of the secure payment system 100. In an example, the parking facility 140 may broadcast 103 its presence. The mobile device 102 within range of the broadcast enables the app to display a list on the mobile device 102 of parking facilities in the user's vicinity which are configured to accept payment via the payment technique described herein. In another example, the identity of parking facilities 140 may be pre-stored in a database accessed by the app via the Internet.

In an example, the user may issue a request 150 to the token provider 110. The request 150 may include the parking facility ID (e.g., a number shown at or near the parking facility) or other identifying information. The request 150 may also include other information about the intended purchase (e.g., parking facility location and time of use) and a payment authorization. For example, the amount of payment may be displayed for the user by the app for the user to accept or approve the item and amount. The user may then select a third party payment processor 130 (e.g., a bank, credit card, or mobile phone service carrier) from the app. This information may be transmitted in the request 150 to the token provider.

The token provider 110 then confirms payment via the third party payment processor 130. For example, the token provider 110 may issue a payment authorization to a third-party payment processor 130, and receive payment approval from the third-party payment processor. After confirming payment, the token provider 110 may generate a token 160a and issue the token 160 to the user's mobile device 102.

After receiving the token 160a, the user may then complete the transaction by the token handler 120 for the selected parking facility 140. In an example, the parking facility 140 is configured with a token handler 120 operatively associated with a control board 121 for the parking facility 140 (e.g., configured to select a parking space and/or time to park at the parking facility 140). The token handler 120 may have a wireless certificate reader configured to receive a token 160b from the mobile device 102. The token 160a and 160b may be the same token provided by the token provider 110, or token 160b may undergo at least some degree of processing at the mobile device 102 before being issued to the token handler 120 for the parking facility 140.

The token handler 120 at the parking facility 140 may then process the token 160b to confirm payment by the user 101. If payment is confirmed, then the token handler 120 for the parking facility 140 may negotiate the transaction (e.g., opening a gate to enable access to a parking area).

As such, the system 100 provides a way for the user 101 to pay for use of the parking facility, using the user's own mobile device 102, but without having to provide direct access to payment details because those are maintained by third party payment processor(s) 150 (e.g., a bank or credit card company).

In an example, various operations of the secure payment system 100 may be implemented at least in part by program code and/or logic circuitry. Program code and/or logic used to implement features of the system can be better understood with reference to the following discussion and various example functions. To the extent program code is implemented, machine-readable instructions may be stored on a non-transient computer readable medium and are executable by one or more processor to perform the operations described herein. Examples of program code may include an end-user mobile device application (or “app”), payment processing application(s), host application (e.g., for generating the token in response to receiving confirmation of payment), and/or a token handling application (e.g., for validating the token received from the end-user device). Of course, the operations described herein are not limited to any specific implementation with any particular type of program code or logic.

It is noted, however, that the secure payment system 100 is not strictly data handling or program code for manipulating data in the traditional sense. That is, the secure payment system 100 may be implemented at least in part in program code (e.g., for generating the token and for various of the transmission protocols). It is to be understood that the secure payment system 100 is also implemented by device hardware which goes beyond a mere computing device provided to execute the program code. Example device hardware may include a wireless certificate reader with a communications interface (e.g., to the mobile device). Example device hardware may also include electronic actuators and/or motors to operate a gate or other access control device, timers, and/or other electronics operable in response to input from the wireless certificate reader and/or other processing device confirming payment.

FIGS. 1C-1D show an example parking facility payment device 170, wherein C) is a front view and D) is a side view. The parking facility payment device 170 may be implemented by the parking facility 140 in FIGS. 1A and 1B.

In an example, the parking facility payment device 170 includes a display 172 showing parking spaces 174a-f for the parking facility 140, and the status of those spaces. The display 172 may show the parking space number. The display 172 may also display a payment indicator such as “PAID”. The display 172 may be suitably mounted, such as on a post 175, wall, etc.

As shown in FIG. 1D, each space on the display 172 may include an output device 176 to illuminate the payment status (e.g., “PAID”). The output device 176 may be operatively associated with the token handler 120 and control board 121 to receive remote payment, as explained above with reference to FIGS. 1A and 1B.

It is noted, however, that the example parking facility payment device 170 shown in FIGS. 1C-1D is merely illustrative and not limiting. For example, the parking facility payment device need not be implemented as a sign, and may instead be configured as a desktop board or display on a tablet (e.g., for a valet). In addition, the parking facility payment device 170 may be operatively associated with a gate or other parking area access device to operate (e.g., open and close) the gate in response to payment for the parking space. In another example, the parking facility payment device 170 may be stand-alone. That is, the parking facility payment device 170 may be a display only, allowing the parking area owner to see which parking spaces have been paid for, and which parking spaces have not been paid for (and to evict or ticket a vehicle that is occupying an unpaid space).

These and other aspects of the secure payment system 100 will be described in more detail below such that the device hardware can be readily implemented by one having ordinary skill in the art after becoming familiar with the teachings herein.

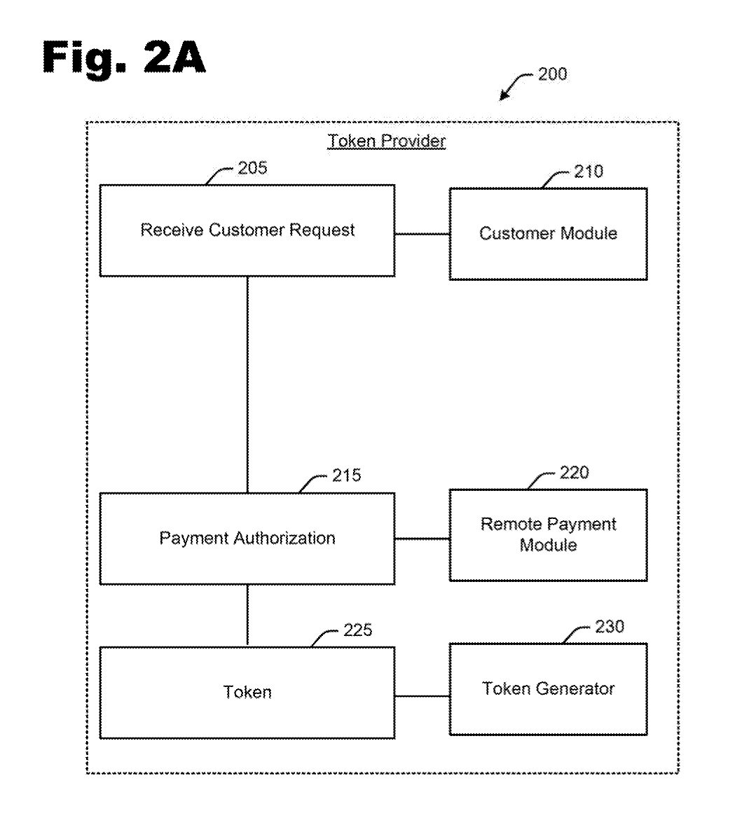

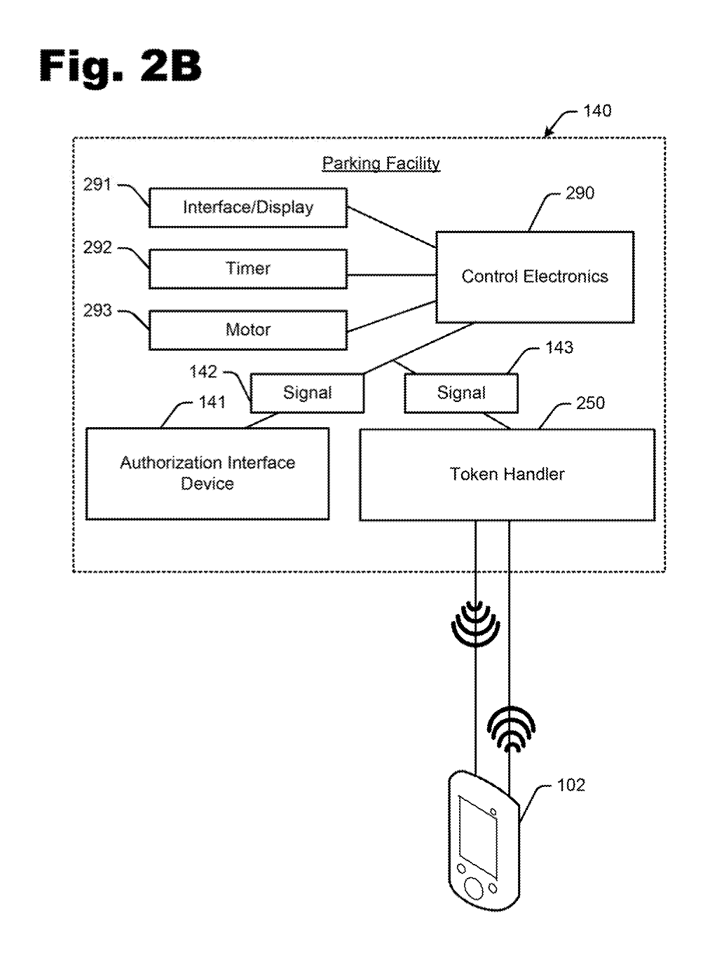

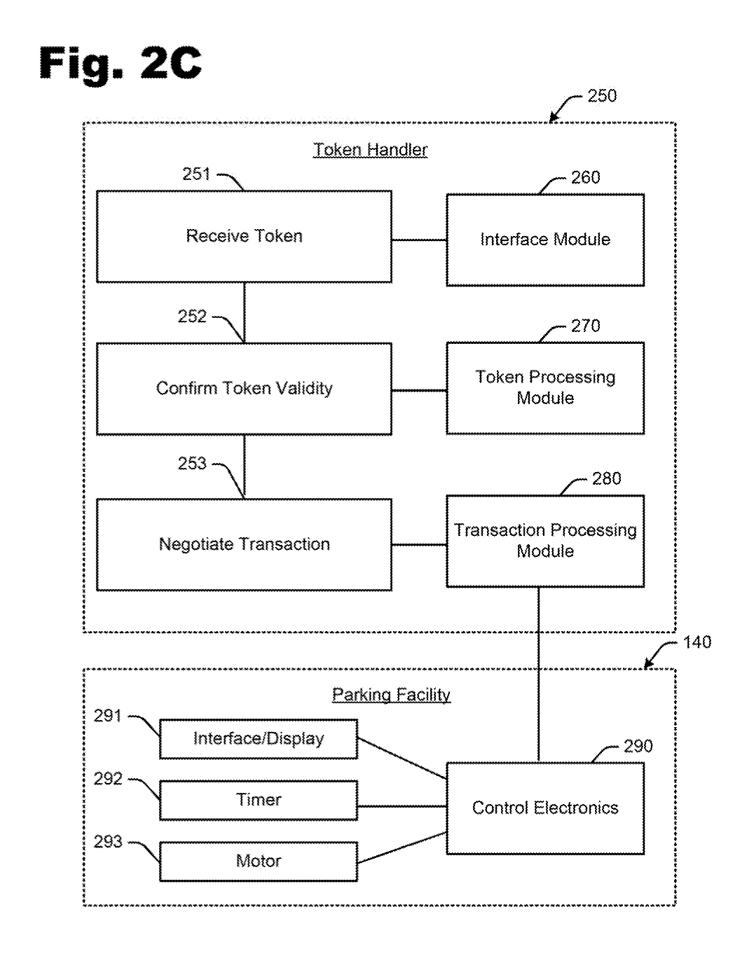

FIG. 2A is a high-level diagram of a token provider 200 (e.g., token provider 110 in FIG. 1B) of the secure payment system. The token provider 200 may receive a request 205 for a transaction (e.g., including a payment amount) at a token handler 120 for the parking facility via a customer module 210. In an example, the request 205 may include information about the parking facility (e.g., identifying information). The token provider 200 issues a payment authorization 215 via a remote payment module 220 to a third-party payment processor. It is noted that the token provider 200 does not actually receive any payment or other personal or confidential payment information from the customer. This information remains confidential as between the customer and the third party payment processor (e.g., the customer's bank or credit card processor). The token provider 200 receives payment approval from the third-party payment processor. The token provider 200 includes a token generator 230 to generate a token 225 and issues the token 225 to the customer so that the customer can complete the transaction at the token handler device configured for the parking facility.

FIG. 2B is a diagram of a token handler device 250 of the secure payment system for a parking facility (e.g., token handler 120 in FIGS. 1A and 1B). For example, the parking facility 140 may be implementing the parking facility payment device 170 shown in FIGS. 1C and 1D.

FIG. 2B illustrates an example where a payment device for the parking facility 140 has an existing payment or authorization interface 141 (e.g., coin-operated, bill-operated, or card reader), and is retrofitted with the token handler device 250 disclosed herein. In an example, retrofitting the token handler device 250 may enable operation by either the existing authorization interface 141 and/or via the token handler device 250. For example, the token handler 250 may be wired between the existing authorization interface 141 and the control electronics 290. In an example, the token handler 250 is connected between the authorization interface 141 and the control electronics 290 without having to cut the existing wiring, e.g., by a coupler that splices through the wire insulation to make an electrical connection with the wiring by press-fit without having to cut the wires. It is noted, however, that the payment device for the parking facility 140 does not need to be retrofitted with the token handler device 250, and the payment device for the parking facility 140 can also be configured from the start with the token handler device 250.

In an example, the existing authorization interface 141 generates an electrical signal 142 or pulse in response to receiving coins or other authorization (e.g., a bill acceptor or card reader). For example, each quarter may generate an electrical pulse thereby indicating a total dollar amount at the control electronics 290. For example, each time a user inserts a quarter, an electrical pulse is issued to the control electronics and the total dollar amount entered is displayed for the user (e.g., $0.25, $0.50, etc.) until the dollar amount is displayed for the desired function.

In an example, the token handler 250 is configured to generate an electrical pulse for each token received by the token handler, or multiple electrical pulses for the total dollar value of the token. For example, the token handler 250 may generate individual electrical pulses for each $0.25 token received. Or if a token is received having a value of $1.25, the token handler 250 may generate five electrical pulses to inform the control electronics 290 of the dollar value received. Parking can then be authorized similarly to the user inserting coins in the existing authorization interface 141, for example, by operating a gate or other access control device, or simply displaying “PAID”.

FIG. 2C is another diagram of a token handler device 250 of the secure payment system for a laundry machine (e.g., token handler 120 for the laundry machine 140 in FIGS. 1A and 1B). Although shown as separate entities in FIG. 2C, as already noted above the token handler 250 may be mounted in or otherwise provided at an access control gate; or the token handler 250 may be provided at physically remote location such as a sign (see, e.g., FIGS. 1C and 1D) indicating a payment status for a parking space.

In an example operation, the token handler device 250 receives a token 251 from the customer (e.g., the token 225 issued to the customer by the token provider 200 in FIG. 2A) via an interface module 260. The token handler device 250 may receive the token 251 from the customer's mobile device via a BLUETOOTH™ or other near-field communication protocol. A token processing module 270 compares data value(s) of the token to data value(s) stored at the token handler device 250. For example, the token processing module 270 may translate the hex value to determine the transaction code and the transaction index, and then compare these to the corresponding device code stored at the associated index location.

The token handler device 250 confirms that the token is valid at 252. If the token is valid, a transaction processing module 280 may negotiate the transaction 253 to enable parking. In an example, the transaction processing module 280 may actuate control electronics 290 of a gate or other access control device, for example by issuing a signal to the control electronics 290. The control electronics 290 may include a computer board on the gate or other access control device, which in turn actuates the motor to open and close the gate. Or the control electronics 190 may actuate an interface or display (see, e.g., FIGS. 1C and 1D), a timer (e.g., as a parking meter), etc. Even a door may be actuated, permitting a valet to enter a garage to retrieve a parked vehicle. Other components and/or functions can also be controlled by actuating via the token handler device 250.

It is noted that the term “module” as used herein means electronic devices (e.g., logic circuitry) and/or machine readable instructions (e.g., firmware) specifically configured to carry out the operations described herein.

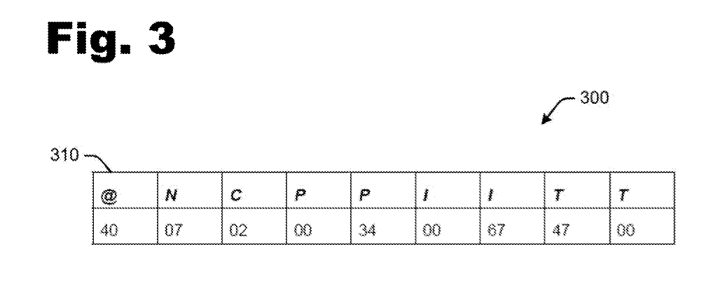

FIG. 3 illustrates example communication and commands 300 which may be implemented by the secure payment system. First, a communications connection may be established. According to the BLUETOOTH™ protocol (e.g., BLUETOOTH™ LE or “BLE,” BLUETOOTH™ 4.0, and BLUETOOTH™ Smart), the token handler has a role of a server or peripheral device, and the user's mobile device has a role of a client or central device.

The token handler advertises its presence (e.g., every 1.00 to 1.25 seconds). The mobile devices scans for nearby token handlers at an interval that is less (e.g., faster) than the advertise interval. In an example, the scan interval and window can be configured with the mobile device. The mobile device may have two methods of scanning for devices (e.g., scan for all devices, or scan only for devices offering a specific service). The latter example is by scanning for a specific UUID that represents a service. By way of illustration, the token handler is represented by the following UUID: c9cab9b8-3abf-4043-a5af-9ad00c6074d5.

After executing the Generic Access Protocol (GAP) to find a device, the Generic Attribute Profile (GATT) can be executed for “service discovery” to find the supported “characteristics” for each service. Each characteristic has an associated UUID and handle, and can be read or written. In an example, UUID's have two lengths (e.g., 16-bit UUID is a standard service or characteristic described by the Bluetooth specification, or a 128-bit UUID is a custom service that is vendor specific). The following table illustrates services and characteristics supported by the token handler in an example.

TABLE 1
Services Provided By Token Handler

| | |
|---|---|
| 1800 | GAP Service |
| 2A00 | Device Name |
| 2A01 | Appearance (0 = Unknown) |
| 180A | Device Information Service |
| 2A29 | Manufacturer Name String (Clancy Systems) |
| 2A24 | Model Number String (Clear Token Meter) |
| 2A27 | Hardware Revision String (B) |
| 2A26 | Firmware Revision String (001.003.000.110) |
| 2A28 | Software Revision String (1.31) |
| c9cab9b8-3abf-4043-a5af- | Token Handler Service |
| 9ad00c6074d5 | |
| 0f314942-e257-46a9-a8c8- | ID (currently the 5 character ID on label, |
| 4c8ecee2cf2b | e.g. AAA01) |
| d5dee9b5-456f-4baa-ad5c- | Command |
| a3f14fd2653c | |
| 2902 | Client Characteristic Configuration |
| | (for Command) |
| d5dee9b6-456f-4baa-ad5c- | Beacon Data (Data1) |
| a3f14fd2653d | |

In the table above, three services provided by the token handler are shown in boldface font. Below each service are the characteristics for each service. The characteristics can be read or written to obtain the values. A handle is assigned to each characteristic. There are routines used to determine the handle based on UUID.

In this example, a GAP service has two characteristics. Device name is currently the ID of the Clear Token Device. The Appearance always reads zero (“unknown”) because the CTD doesn't fall into a pre-defined category of Heart Rate Monitor, Phone, etc.

Some devices (e.g., APPLE™ devices) require that a Device Information Service be provided on each Bluetooth device. The characteristics are self-explanatory.

The Token Handler Service has three characteristics and one Client Characteristic Configuration. The ID is read only and is the ID that is on the label of the meter. The command characteristic can be written and a return code can be read. Before the command characteristic can be used, a value of 0001 is written to the Client Characteristic Configuration. Some Bluetooth stacks do this automatically. Also, some clients may need to send the value as 0100 instead of 0001. Other examples are also contemplated.

Commands and data can now be exchanged with the token handler. Commands are sent to the token handler by writing up to 20 bytes to the Command characteristic handle. Data is received back through the same handle with “notification”.

After communication, the connection is disconnected. The token handler finishes carrying out any tasks, then goes back to sleep. This strategy helps to minimize connection time to the token handler device to conserve battery power.

In an example, the commands and data are in arrays of bytes, with values from 0x00 to 0xFF. The number of bytes sent or received through the FIFO handle is 20 or less at a time. All commands to the CTD begin with a 0x40 (@). The next byte in the array is the number of remaining bytes in the command. In an example, the general format of a command is @ N C P P I I T T, where:
@=0x40
N=Number of bytes to follow
C=Command code (1 byte)
P=Parameters for the command (number of bytes varies with each command)
I=Index of the validating token (2 bytes, most significant first)
T=validating token (2 bytes, most significant first)

To make the process even more secure, the code can be sent from the user's mobile device as a two part message, wherein part one is a gatekeeper command or message including a unique code and informing the token handler for the parking facility that part two is following, and then another unique code is sent as part two as an activating command or message. This technique implements two codes for each transaction.

In this example, all replies from the CTD begin with a 0x52. The next byte in the array is the remaining number of bytes in the reply. In an example, the general format of a reply is: R N S, where:
R=0x52
N=number of bytes to follow
S=status (0x01 if command was successful or 0x00 if there was an error)

Validating tokens may also be implemented with the commands. For example, there may be 65536 index positions (0-65535), with each index containing a token with a value from 1-65535. Once a token is used, it is zeroed to prevent re-use and thus reduce fraud.

If an incorrect index/token combination is received, the device responds with a status of 0x00, and not respond to further commands until some time has passed.

In FIG. 3, the following abbreviations are used:
@=0x40—Start of the command
N=Number of bytes to follow
C=Command Code
P=Time (used in Closure & Backlight)
I=Index Value
T=Token Value
H=Hours
M=Minutes
S=Seconds
R=Reset (00=No Reset−01=Reset)

Command 310 is an example Contact Closure Command. This command closes the relay contact for the specified length of time. The length of time the contact remain closed is the number of 3.90625 millisecond units ( 1/256 of a second) specified with 2 bytes. For example, to close the contact for 1 second, a value of 0x0100 is used; to close the contact for a half second, a value of 0x0080 is used. A value of less than 0x0034 (200 mS) should not be used for this example. @N C P P I I T T, where:
@=0x40
N=0x07, number of bytes to follow
C=0x02
P=length of time for contact closure, MSB first, range 0x0034-0xFFFF I=index of validating token, MSB first T=validating token, MSB first

Reply: R N S R=0x52, where:
N=0x01, number of bytes to follow
S=0x01 if command and token were successful, 0x00 if index/token was not valid or some other error.

Other commands (not shown in FIG. 3), include by way of illustration, an Enable Beacon Command (0x05). This command enables the token handler to alternate advertising between any of several supported beacon formats. For example, with the uriBeacon, the final 18 bytes of the advertisement data are the encoded URL including prefix byte. This data is written to the GATT attribute database (Beacon Data, see table above) prior to sending the command. In another example, with the iBeacon, 20 bytes of the advertisement data are the UUID and the “major” and “minor” fields. This data is written to the GATT attribute database (Beacon Data, see table above) prior to sending the command.

The rate at which advertising packets are sent doubles when the beacon function is enabled, thus impacting battery life. @N C B I I T T, where:
@=0x40
N=0x06, number of bytes to follow C=0x05
B=0: no beacon, 1: uriBeacon, 2: Apple iBeacon I=index of validating token, MSB first T=validating token, MSB first
Reply: R N S R=0x52 N=0x01
S=0x01 if command and token were successful, 0x00 if index/token was not valid or some other error.

In another example, a Change Transmit Power Command (0x06) changes the transmit power of the CTD. In an example, there are three power levels: low, medium, and high. The default transmit power level after cycling the device power is medium. @N C P I I T T, where:
@=0x40
N=0x06, number of bytes to follow C=0x05
P=0: Low, 1: Medium
(default), 2: max I=index
of validating token, MSB
first T=validating token,
MSB first
Reply: R N S R=0x52 N=0x01
S=0x01 if command and token were successful, 0x00 if index/token was not valid or some other error.

In another example, a Contact Pulse Command (0x08) momentarily closes (pulses) the relay contact, a specified number of times, for a specified length of time, with a specified spacing between pulses. This can be implemented to mimic coins passing through a coin acceptor in vending applications. @N C P D S I I T T, where:
@=0x40
N=0x08, number of bytes to follow C=0x08
P=Number of pulses, 0-255 (0x00-0xFF)
D=Pulse duration, 1=200 mS, 2=500 mS S=Time between pulses, 1=200 mS, 2=500 mS, 3=one second.
I=index of validating token, MSB first T=validating token, MSB first
Reply: R N S R=0x52
N=0x01, number of bytes to follow
S=0x01 if command and token were successful, 0x00 if index/token was not valid or some other error.

The above example commands are provided for purposes of illustration, but are not intended to be limiting. Still other commands are contemplated as being within the scope of the disclosure herein, as will be readily appreciated by those having ordinary skill in the art after becoming familiar with the teachings herein.

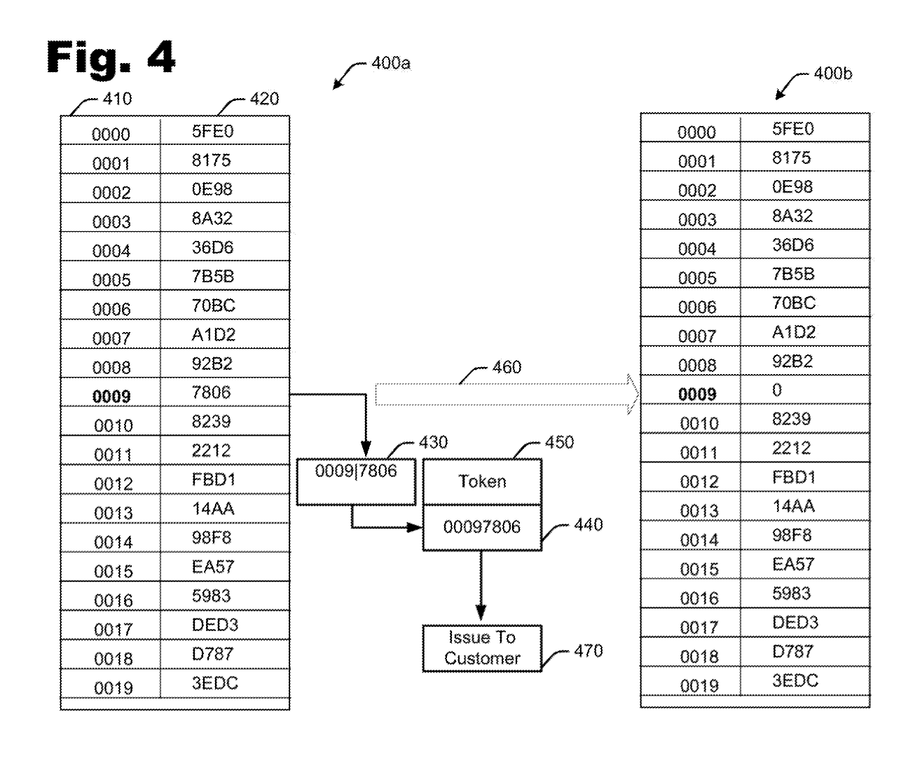

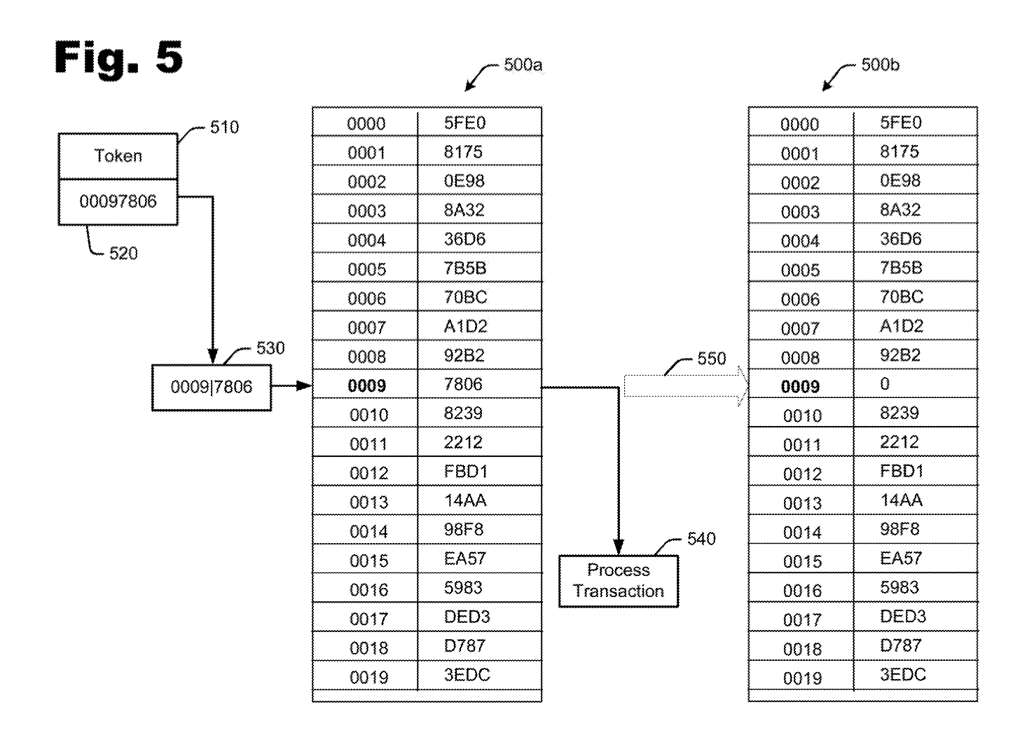

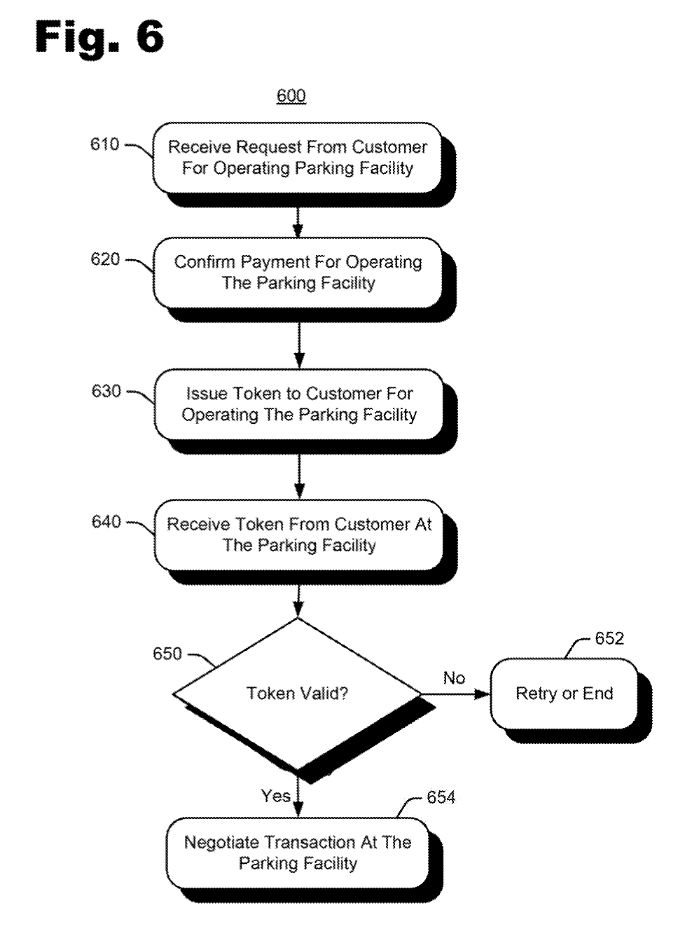

FIG. 4 illustrates an example coding scheme to build a token at a token provider. FIG. 6 illustrates an example coding scheme to validate the token illustrated in FIG. 4, and process a transaction by a token handler for the parking facility. The tables 400a-b in FIG. 4 and tables 500a-b in FIG. 5 illustrate a code sample (the first 20 entries of 65,536 entries are shown). The first column represents an index (1 through the number of entries), and the second column represents the corresponding code for the index entry. The codes shown in FIG. 4 may be stored at the token provider (e.g., token provider 110 shown in FIG. 1B) and used to generate the token. These same codes (shown in FIG. 5) may also be written to the token handler for the parking facility by “injecting” the codes in hardware stored in or associated with the token handler for the parking facility. Each token handler includes its own set of unique codes in an indexed array, stored in memory internal to the token handler for the parking facility.

During set up, the token handler may be read (e.g., for device ID or location number, and a corresponding code). The codes may be compared to a database record stored by the token provider. If there is a match, then the token handler has been property set up, and is ready for use by the customer.

During use, the user may open a phone app and select the location or other ID of the parking facility. The location or other ID of the parking facility may be transmitted by nearby mobile devices (e.g., using Bluetooth or other communications protocol), or the user may manually enter the location or other ID. A request is generated on the user's mobile device, including the location and/or other information for the parking facility. Additional information may also be included in the request (e.g., time duration paid for parking, ID number for a parking space, ID of a valet, etc.). The user may also select a payment processor (e.g., a bank, credit card processor, PayPal®, etc.) to be included in the request. The user may be prompted to use the last payment processor used or enter a new payment processor.

The request is sent to the token provider to authorize payment. The payment processor may charge the user's account and return “Approved” or “Declined” to the token provider. The digital payment service may notify the user (e.g., if payment was declined). But the token provider never receives personal or financial information or credit card information of the user.

If the payment is approved, then the token provider may build a token for the user to deliver to the token handler for the parking facility. In an example, the token may include a location code, duration or activation code, security code (FIG. 4), and optionally an advertisement or other information for the user to view. For example, the token provider may select transaction index (e.g., index location 0009) from the index column 410 and read a corresponding transaction code (e.g., hex 7806 representing decimal 30726) from the code column 420, as illustrated by the numbers 430 in FIG. 4. It is noted that any suitable system (e.g., alpha-numeric) may be used, and is not limited to a numbering system.

In this example, the numbers are in hexadecimal and added (e.g., as packet 440) to the token 450. The table 400a may be updated as illustrated by arrow 460 and shown as updated table 400b, wherein the code at index location 0009 is set to “0”. The token 450 may then be issued to the customer as illustrated by block 460.

The user may then relay the token 510 including the hexadecimal 520 to the token handler, as illustrated in FIG. 5. The token handler receives the token, and validates the transaction code in the token (FIG. 5), for example by reading the token packet 520 and comparing the index and hex code 530 with the corresponding index location 0009 of the device index. If the device code at index location 0009 in table 500a matches the transaction code in the token 510, the token handler may negotiate or process the transaction 540 by executing a device command (e.g., operate a gate or parking timer).

The token handler may also update/modify the table 500a, as illustrated by arrow 550, to indicate that the code has been used (e.g., by setting the code in index 9 to all 0's) as shown by updated table 500b in FIG. 5. As such, the index location 9 cannot be re-used, thereby preventing fraudulent use.

In this example, a small 128K file contains 65,536 unique codes. For a parking facility being used on average 20 times a day, the original codes are predicted to last about 9½ years. For a busy location being accessed 100 times a day, the original codes are predicted to last about 2 years. In the event that the codes need to be changed or updated, a secure update procedure may be implemented to refresh the codes in the field.

It should be understood that the systems and techniques described above may be modified within the scope of the disclosure herein, and are not limited to any particular implementation. For example, the example code and indexing illustrated in the figures is illustrative and not limiting.

FIG. 6 is a flow chart illustrating example operations 600 which may implement a digital payment method. In example operation 610, a request for a transaction for a parking facility may be received from a customer by a token provider. The token provider confirms payment for the transaction in operation 620, and then issues a token to the customer in operation 630. In an example, the token has a transaction index and a corresponding transaction code.

In operation 640, the token is received from the customer. For example, the token may be received from the customer's mobile device via a BLUETOOTH™ or other near-field communication protocol with the token handler for the parking facility. In operation 650, the token handler for the parking facility confirms validity of the token, e.g., based on the transaction index and the transaction code. If the token is not valid, operations may end with operation 652. In another example, the token handler may issue feedback to the user (e.g., to retry by sending a different token). If the token is valid, the token handler may negotiate the transaction for the parking facility in operation 654. In an example, the token handler may start, set (or add) an operating time for the customer to use the parking facility.

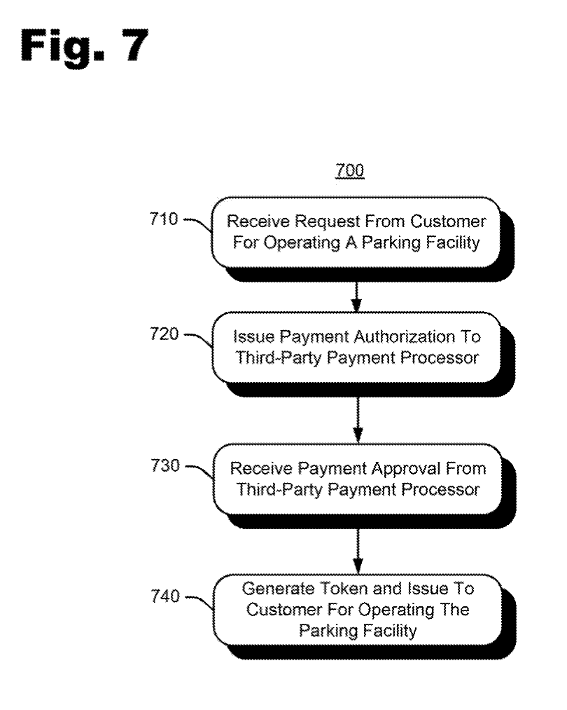

FIG. 7 is a flow chart illustrating example operations 700 of a token provider to implement a digital payment method. In operation 710, the token provider may receive a request for a transaction for a parking facility from a customer. In an example, the request may include information about the parking facility (e.g., identifying information). In operation 720, the token provider issues a payment authorization to a third-party payment processor. It is noted that the token provider does not actually receive any payment or other personal or confidential payment information from the customer. This information remains confidential as between the customer and the third party payment processor (e.g., the customer's bank or credit card processor). In operation 730, the token provider receives payment approval from the third-party payment processor.

In operation 740, the token provider generates a token and issues the token to the customer so that the customer can complete the transaction for the parking facility. In an example, the token includes a hex value representing the transaction code and the transaction index.

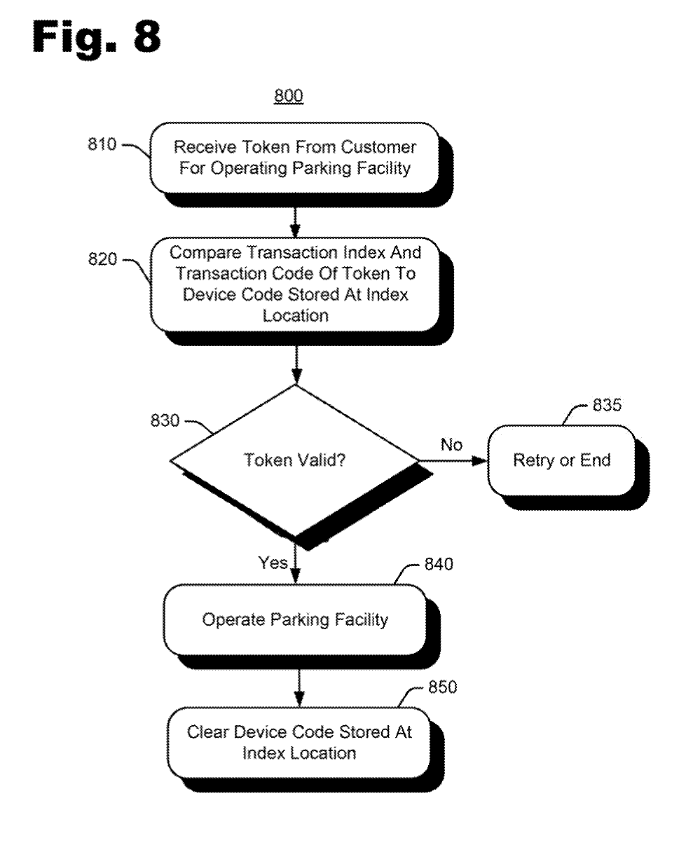

FIG. 8 is a flow chart illustrating example operations 800 of a token handler to implement a digital payment method. In operation 810, the token handler for the parking facility receives a token from the customer (e.g., the token issued to the customer by the token provider in operation 740). The token handler may receive the token from the customer's mobile device via a BLUETOOTH™ or other near-field communication protocol. In an example, the token includes a hex value representing the transaction code and the transaction index.

In operation 820, the token handler compares the transaction index and transaction code of the token to a device code stored at corresponding index location at the token handler. For example, the token handler may translate the hex value to determine the transaction code and the transaction index, and then compare these to the corresponding device code stored at the associated index location at the token handler.

In operation 830, the token handler determines whether the token is valid. If the token is not valid, operations at the token handler may end with operation 835. In another example, the token handler may issue feedback to the user (e.g., to retry by sending a different token).

If the token is valid, the token handler may negotiate the transaction at operation 840. In an example, the token handler may activate, set (or add) a time duration for the customer to use the parking facility.

In operation 850, the token handler dears the device code stored at the index location so that the token cannot be reused.

Example operations shown in FIGS. 6-8 are illustrative and not intended to be limiting. The ordering of operations is not limited to the ordering shown in the drawings. Still other operations are also contemplated, as will become readily apparent to those having ordinary skill in the art after becoming familiar with the teachings herein.

It is noted that the examples shown and described herein are provided for purposes of illustration and are not intended to be limiting. Still other examples are also contemplated.

1. A digital payment method for a parking facility, the method comprising:
receiving a request from a customer for a transaction for the parking facility;
confirming payment by the customer for the transaction for the parking facility;
issuing a token to the customer for the transaction for the parking facility, the token having a transaction index and a transaction code for the parking facility;
receiving the token from the customer at an electronic token handler device for the parking facility;
confirming validity of the token at the electronic token handler device for the parking facility based on the transaction index and the transaction code for the parking facility; and
negotiating the transaction for the customer by the electronic token handler device for the parking facility.

2. The method of claim 1, further comprising retrieving identifying information for the parking facility based on the request from the customer.

3. The method of claim 1, wherein confirming payment by the customer for the transaction for the parking facility comprises:
issuing a payment authorization to a third-party payment processor; and
receiving payment approval from the third-party payment processor.

4. The method of claim 1, wherein confirming validity of the token at the electronic token handler device for the parking facility comprises comparing the transaction index and the transaction code of the token to a device code stored at an index location associated with the parking facility.

5. The method of claim 4, further comprising clearing the device code at the index location associated with the parking facility so that the token cannot be reused.

6. The method of claim 1, further comprising executing a device command at the electronic token handler device for the parking facility if the token is valid.

7. The method of claim 1, wherein the token includes a hex value representing the transaction code and the transaction index for the parking facility.

8. A secure payment system for a parking facility, the system comprising:
an electronic token handler device for the parking facility, the electronic token handler device configured to receive a token from the customer for a transaction for the parking facility, the electronic token handler device further configured to confirm validity of the token based on a transaction index and a transaction code of the token for the parking facility;
wherein the electronic token handler device is electronically connected to control electronics to operate a motor, display, or other electronic device of the parking facility in response to a signal received from the electronic token handler device after confirming receipt of a valid token.

9. The system of claim 8 further comprising a remote payment module to confirm payment by the customer for the parking facility, and to issue the token to the customer, the token having the transaction index and the transaction code to actuate the motor of the parking facility.

10. The system of claim 9, wherein the remote payment module receives identifying information of the parking facility from the request by the customer.

11. The system of claim 9, wherein the remote payment module confirms payment for use of the parking facility by:
issuing a payment authorization to a third-party payment processor; and
receiving payment approval from the third-party payment processor.

12. The system of claim 11, wherein the remote payment module confirms payment without receiving confidential payment information from the customer.

13. The system of claim 8, wherein the electronic token handler device confirms validity of the token by comparing the transaction index and the transaction code of the token to a device code corresponding to an index location associated with the parking facility.

14. The system of claim 13, wherein the electronic token handler device dears the device code at the index location associated with the parking facility so that the token cannot be reused.

15. The system of claim 14, wherein the device code associated with the parking facility is refreshed via a secure field procedure.

16. The system of claim 8, wherein the token includes a hex value representing the transaction code and the transaction index for operating the parking facility.

17. A secure payment system for a parking facility, the system comprising:
a remote payment processor to confirm payment by a customer for a transaction for the parking facility, and to issue a token to the customer for the transaction, the token having a transaction index and a transaction code for the parking facility;
an electronic interface module at the parking facility configured to receive the token from the customer for the transaction;
a token handler device having a token processing module to confirm validity of the token based on the transaction index and the transaction code of the token, the token handler issuing a signal to actuate control electronics at the parking facility in response to a valid token.

18. The system of claim 17, wherein the remote payment processor is configured to issue a payment request to a third-party payment processor, and receive payment approval from the third-party payment processor.

19. The system of claim 17, wherein the payment module confirms validity of the token by comparing the transaction index and the transaction code of the token to a device code stored at an index location associated with the parking facility.

20. The system of claim 17, wherein the payment module dears the device code stored at the index location associated with the parking facility after negotiating the transaction so that the token cannot be reused.
